(19) United States
(12) Patent Application Publication
(10) Pub. No.: US 2004/0051901 A1
(43) Pub. Date: Mar. 18, 2004

(54) Information processsing apparatus, a function extension program, computer readable storage medium storing the program, and information processing method

(75) Inventor: Masato Fukuda, Chiba (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/660,651

(22) Filed: Sep. 12, 2003

(30) Foreign Application Priority Data
Sep. 13, 2002 (JP) 2002-269246

(51) Int. Cl. B41J 1/00; G06F 15/00

(52) U.S. Cl. 358/1.16; 358/1.15

(57) ABSTRACT

The present invention provides a function extension program that can communicate with a software for controlling a printer. This program causes a computer to execute a process of accepting a print instruction for a plurality of image data, a process of acquiring a list of identification information for the image data transmitted to the printer from first image list memory storing the list, a process of managing to store a list of identification information for the image data to be printed that is included in the print instruction in second image list memory, a process of comparing the list stored in the first image list memory and the list stored in the second image list memory, and a process of requesting the server device connected via a network for the image data that is included in the list stored in the second image list memory but not included in the list stored in the first image list memory, as a result of comparison by the comparison means.

### FIELD OF THE INVENTION

The present invention relates to an information processing apparatus, a function extension program, a computer readable storage medium storing the program, and an information processing method.

### BACKGROUND OF THE INVENTION

Conventionally, there is an information processing apparatus connected via a network to a server device, in which the information processing apparatus has a function of outputting image data acquired from the server device to a printer.

However, in the conventional system, when a client terminal downloads image data stored in the server device and outputs it to the printer, it has been required to download all the image data to be printed from the server device every time the printing process is performed. As a result, this requires a lot of time to download the image data.

### SUMMARY OF THE INVENTION

The present invention has been achieved to solve the above-mentioned problems associated with the prior art. Accordingly, an object of the present invention is to output the image data acquired from the server device to the printer efficiently.

In order to achieve the above object, the present invention provides an information processing apparatus that can communicate with a server device via a network and control a printer, comprising:

image data memory for storing image data transmitted to the printer;

first image list memory for storing a list of identification information for the image data stored in the image data memory;

print instruction acquiring means for acquiring a print instruction indicating that the image data stored in the server device should be printed;

second image list memory for storing a list of identification information for the image data to be printed that is included in the print instruction acquired from the print instruction acquiring means;

comparison means for comparing the list stored in the first image list memory and the list stored in the second image list memory; and

download means for downloading, from the server device, the image data that is included in the list stored in the second image list memory but not included in the list stored in the first image list memory, as a result of comparison by the comparison means.

In order to achieve the above object, this invention provides a function extension program that can communicate with a software for controlling a printer, the program causing a computer to execute:

a process of accepting a print instruction for a plurality of image data;

a process of acquiring a list of identification information for the image data transmitted to the printer from first image list memory storing the list;

a process of managing to store a list of identification information for the image data to be printed that is included in the print instruction in second image list memory;

a process of comparing the list stored in the first image list memory and the list stored in the second image list memory; and

a process of requesting the server device connected via a network for the image data that is included in the list stored in the second image list memory but not included in the list stored in the first image list memory, as a result of comparison by the comparison means.

The function extension program may further cause a computer to execute a process of managing to store the acquired image data by requesting the server device connected via the network in image data memory, and a process of updating the list stored in the first image list memory with the list stored in the second image list memory.

The function extension program may further cause a computer to execute a process of acquiring the image data included in the list stored in the second image list memory from the image data memory, depending on a result of the comparison.

The function extension program may further cause a computer to execute a process of transferring the acquired image data included in the list stored in the second image list memory to the software.

The function extension program may further cause a computer to execute a process of managing to delete, from the image data memory, the image data corresponding to the identification information that is included in the list stored in the first image list memory but not included in the list stored in the second image list memory, depending on a result of the comparison.

The function extension program may further cause a computer to execute a process of communicating with the WWW browser, wherein the function extension program is executed based on the description of an HTML file acquired by the WWW browser.

This invention provides an information processing apparatus comprising:

means for executing the function extension program; and

means for communicating with the server device or the printer.

In order to achieve the above object, this invention provides an information processing method for extending the functions of a software for controlling a printer, comprising:

a step of accepting a print instruction for a plurality of image data;

a step of acquiring a list of identification information for the image data transmitted to the printer from first image list memory storing the list;

a step of managing to store a list of identification information for the image data to be printed that is included in the print instruction in second image list memory;

a step of comparing the list stored in the first image list memory and the list stored in the second image list memory; and

a step of requesting the server device connected via a network for the image data that is included in the list stored in the second image list memory but not included in the list stored in the first image list memory, as a result of comparison by the comparison means.

In order to achieve the above object, a storage medium of the invention stores the program.

Other features and advantages of the present invention will be apparent from the following description taken in conjunction with the accompanying drawings, in which like reference characters designate the same or similar parts throughout the figures there.

### BRIEF DESCRIPTION OF THE DRAWINGS

FIG. 1 is a block diagram showing a system according to a first embodiment of the present invention;

FIG. 2 is a block diagram showing the internal configuration of an information processing apparatus according to the first embodiment of the invention;

FIG. 3 is an explanatory view for explaining a print setting window of the information processing apparatus according to the first embodiment of the invention;

FIG. 4A is a flowchart showing a plug-in process in the information processing apparatus according to the first embodiment of the invention;

FIG. 4B is a flowchart showing a plug-in process in the information processing apparatus according to the first embodiment of the invention;

FIG. 5 is a block diagram showing a system according to a second embodiment of the invention; and

FIG. 6 is a flowchart showing a plug-in process in the information processing apparatus according to the second embodiment of the invention.

FIG. 7 is a view showing the album display window according to the first embodiment of the present invention.

### DETAILED DESCRIPTION OF THE PREFERRED EMBODIMENTS

[First Embodiment]

<Configuration>

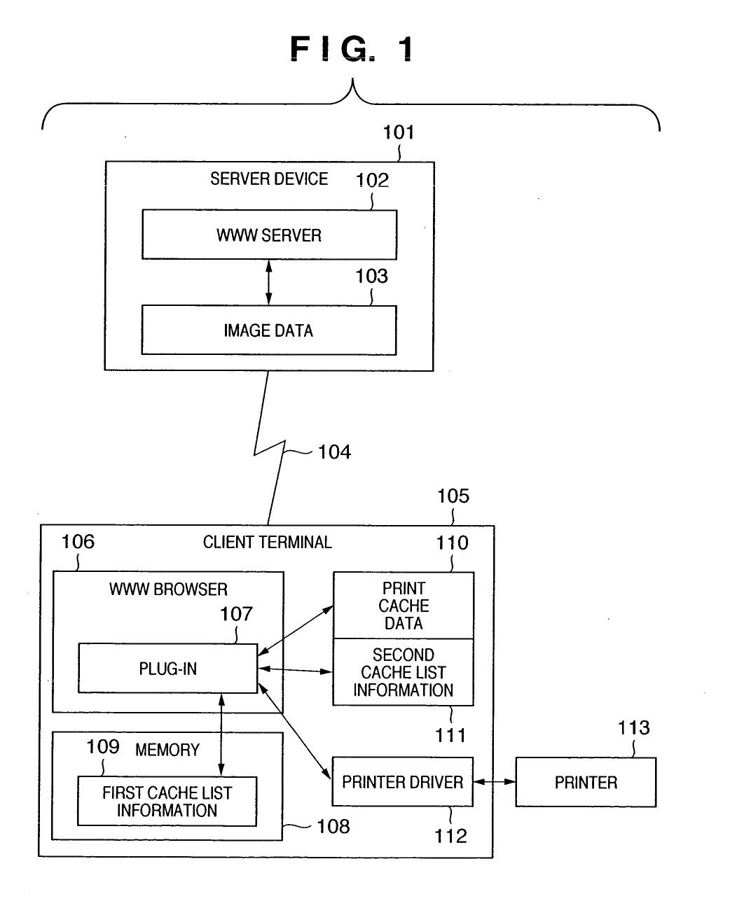

FIG. 1 is a block diagram showing the schematic configuration of a system to which an information processing apparatus is applicable according to a preferred embodiment of the present invention.

In FIG. 1, reference numeral 105 denotes a client terminal in this embodiment. The client terminal 105 is connected to a server device 101 via a network 104 such as the Internet or a local area network (LAN).

The server device 101 is an information processing apparatus group at the site which provides the service for preserving the image data 103 transferred via the network 104. The server device 101 has a WWW server 102 for receiving various kinds of requests via the network 104 and transmitting various kinds of responses.

Reference numeral 106 denotes a WWW (World Wide Web) browser operating on the client terminal 105. The WWW browser 106 acquires various kinds of HTML files described in HTML (Hyper Text Markup Language) from the WWW server 102 on the server device 101 via the network 104. And the WWW browser 106 has a function of interpreting the description of an HTML file and displaying it on a display device (CRT 201 as will be described later) of the client terminal 105.

Reference numeral 107 denotes function extension means (plug-in) for extending the function of the WWW browser 106. The WWW browser 106 interprets the HTML file, and executes the plug-in 107 corresponding to the description content, when there is the description for specifying the execution of the plug-in 107.

Reference numeral 112 denotes a software for controlling the printer 113 connected with the client terminal 105. The plug-in 107 demands a printer driver 112 via an operating system (OS) to print the image data or document data. The printer driver 112 interprets a print instruction from the plug-in 107 that is received via the OS and performs the print processing for the printer 113.

Reference numeral 103 denotes the image data stored in a storage portion of the server device 101 or an external storage unit connected to the server device 101. If the WWW browser 106 requests the WWW server 102 to display the image data 103, the WWW server 102 prepares an HTML file for displaying the image data 103 on the WWW browser 106, and sends it out via the network 104 to the WWW browser 106. The WWW browser 106 analyzes the HTML file and displays the image data 103 on the CRT 201.

The printer 113 is a printing apparatus connected to the client terminal 105, and particularly may be an inkjet printer or a laser beam printer.

The first cache list information 109 is stored in a memory 108 within the client terminal 105. This is the list information in which the file information of the image data 103 selected as the objects to be printed on the WWW browser 106 is listed up.

Reference numeral 110 denotes a print cache data area. The client terminal 105 saves the image data 103 received from the server device 101 in the print cache data area 110 within the client terminal 105 to make the printing.

Reference numeral 111 denotes the second cache list information. This is the list information in which the file information of the image data 103 saved in the print cache data area 110 is listed up.

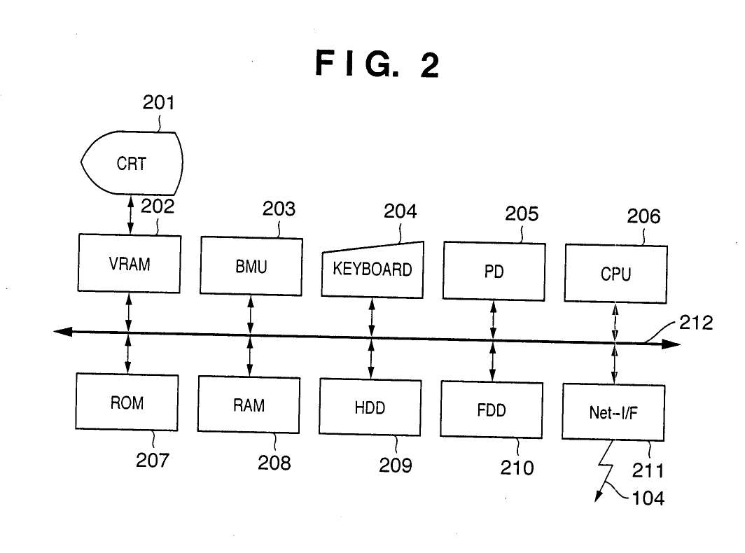

FIG. 2 is a block diagram showing the schematic internal configuration of the client terminal 105 according to this embodiment of the invention.

In FIG. 2, reference numeral 201 denotes a CRT (display unit), in which a document during editing, graphics, image, editing information, icon, message, menu and user interface information are displayed on its display screen. Reference numeral 202 denotes a VRAM, on which an image to be displayed on the display screen of the CRT 201 is drawn. The image data generated by this VRAM 202 is transferred to the CRT 201 in a predetermined way, whereby the image is displayed on the CRT 201. Reference numeral 203 denotes a bit move unit (BMU) for controlling the data transfer between memories (e.g., VRAM 202 and other memory), or data transfer between the memory and each I/O device (e.g., network interface 211), for example. Reference numeral 204 denotes a keyboard having various kinds of keys for entering the document. Reference numeral 205 denotes a pointing device that is employed to designate icons, the menu and other objects displayed on the display screen of the CRT 201, for example. Reference numeral 206 denotes a CPU for controlling each device connected to a CPU device on the basis of a control program stored in a ROM 207, a hard disk or a floppy disk (registered trademark). Reference numeral 207 denotes the ROM for holding various control programs and data.

Reference numeral 208 denotes a RAM having a work area of the CPU 206, a data saving area for the error processing, and a load area for the control program. Reference numeral 209 denotes a hard disk drive (HDD) for controlling access to the hard disk. Reference numeral 210 denotes a floppy disk (registered trademark) drive (FDD) for controlling access to the floppy disk (registered trademark). Reference numeral 211 denotes a network interface for enabling communication with other information processing apparatus or the printer via the network 104. Reference numeral 212 denotes a CPU bus, including an address bus, a data bus and a control bus. The control program for the CPU 206 may be provided from the ROM 207, the hard disk or the floppy disk (registered trademark), or from other information processing apparatus via the network 104.

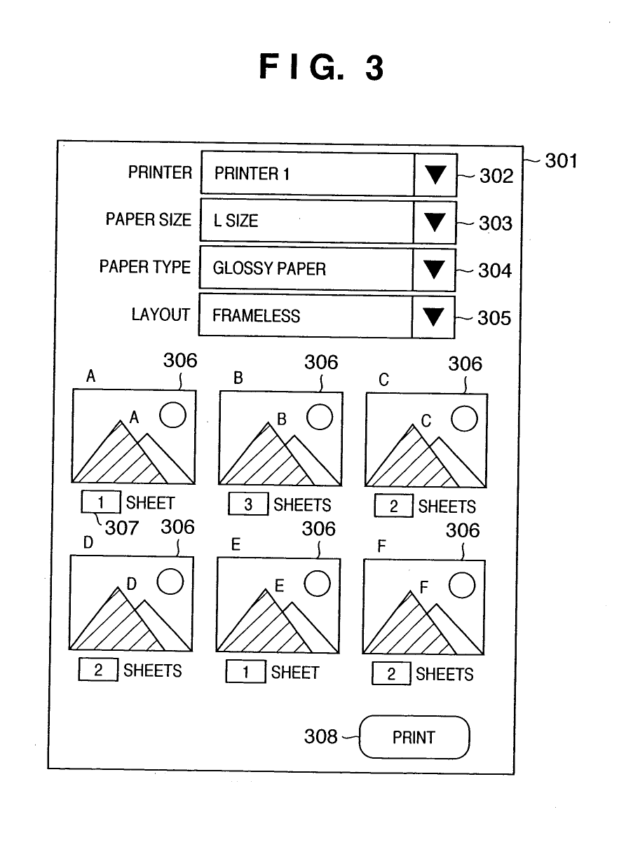

FIG. 3 is an explanatory view for explaining a print setting window that is displayed on the CRT 201 at the client terminal 105.

Reference numeral 301 denotes a window to be displayed by the WWW browser 106, which is a window for displaying in succession the thumb nails 306 of the image data 103 stored within the server device 101.

Reference numeral 302 denotes a list box for designating the printer for making the printing, 303 denotes a list box for designating the paper size of the object to be printed, 304 denotes a list box for designating the type of paper, and 305 denotes a list box for designating a layout on the paper to be printed. The list box 302 lists the information of the printer connected to the client terminal 105, which is acquired from the OS by the plug-in 107. Also, the list boxes 303 to 305 list the attribute information of the printer which is acquired from the printer driver 112 by the plug-in 107.

Reference numeral 307 denotes an edit box for designating the number of prints for each image data 306 to be printed.

Reference numeral 308 denotes a print button for designating the execution of the printing, in which the user makes an instruction on the print button 308 by operating the pointing device 205.

<Printing process>

A printing procedure of this embodiment will be described below using the flowcharts.

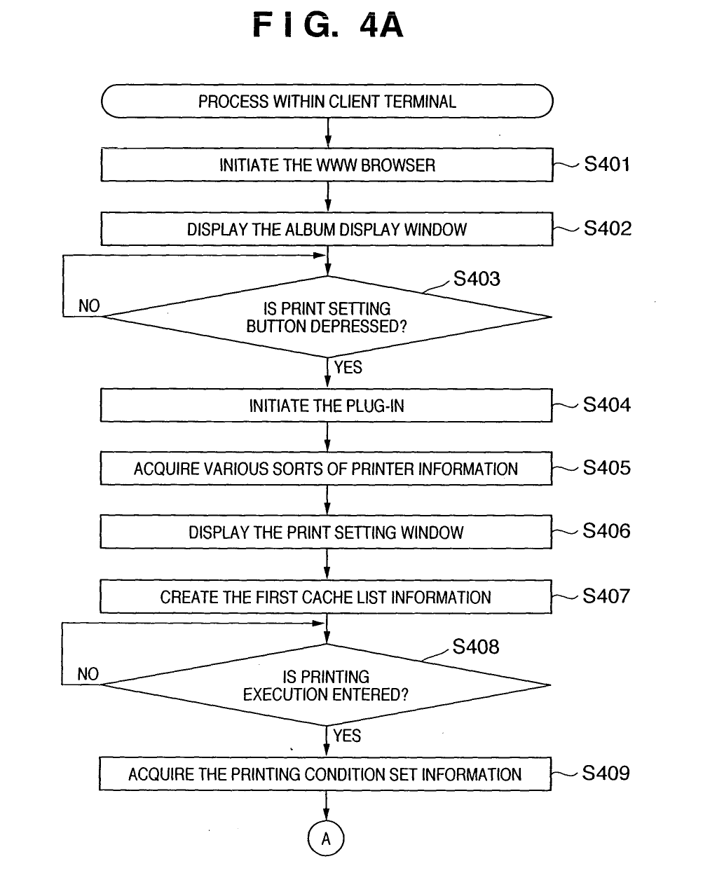

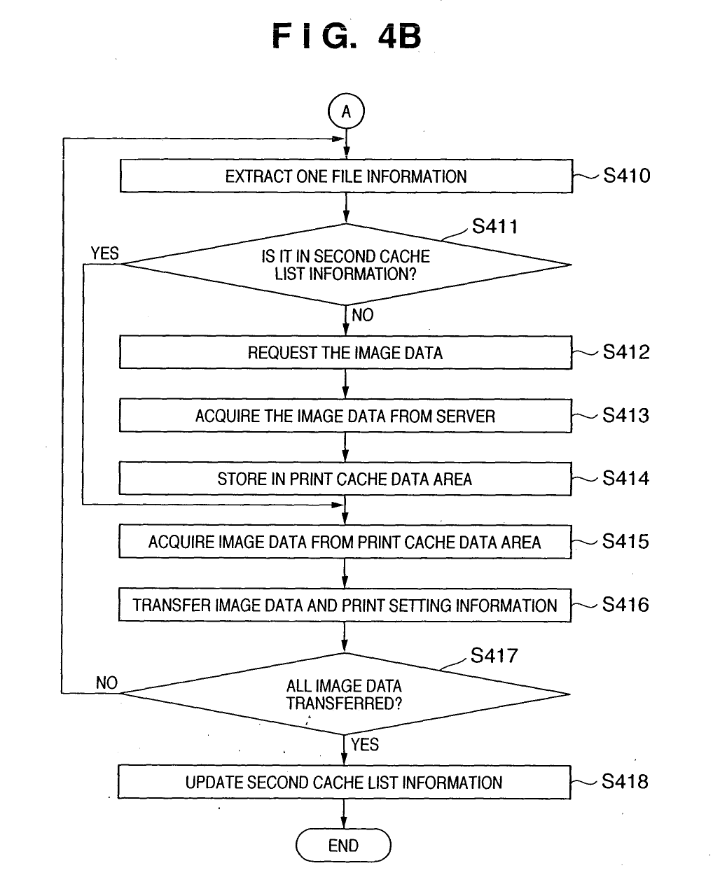

FIGS. 4A and 4B are the flowcharts showing a printing procedure at the client terminal 105.

In FIG. 4A, first of all, at step S401, the WWW browser 106 on the client terminal 105 is initiated by an operation of the user.

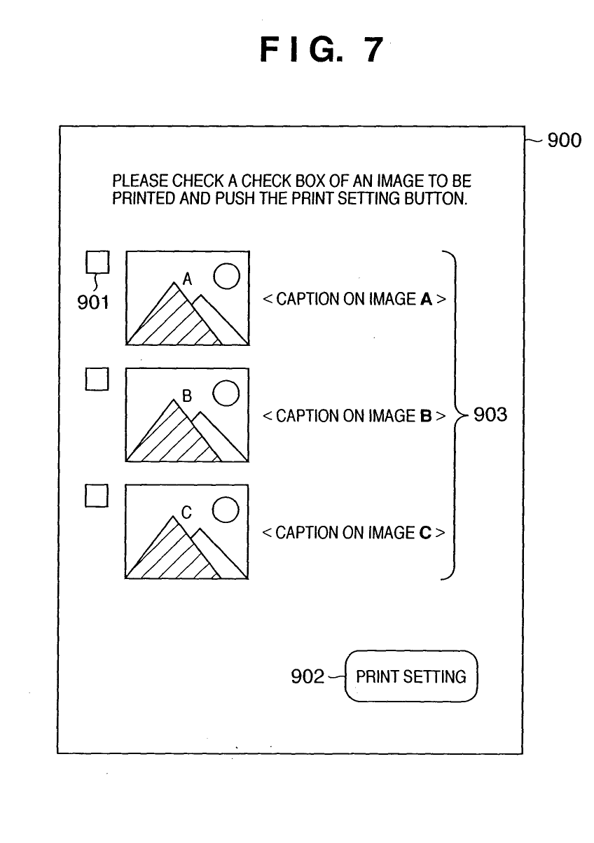

At step S402, the WWW browser 106 is connected via the network 104 to the WWW server 102 of the server device 101 to acquire various kinds of HTML file. And an album display window 900 as shown in FIG. 7 is displayed on the basis of the acquired HTML file.

At step S403, it is checked whether or not an instruction for starting the print setting is input by the user operation of depressing a print setting button 902 on the album display window 900 of FIG. 7.

At step S404, the WWW browser 106 initiates the plug-in 107 on the basis of the HTML file acquired from the WWW server.

At step S405, the plug-in 107 acquires via the OS the information of the printer 113 (e.g., device name, printer name) connected to the client terminal 105. Also, the plug-in 107 acquires the attribute information of the printer 113 (e.g., paper size of the paper set on the printer 113, kind of paper, layout printable by the printer 113) from the printer driver 112 of the printer 113.

At step S406, the WWW browser displays the print setting window 301 of FIG. 3 on the basis of the HTML file acquired from the server device 101. On the print setting window 301 of FIG. 3, the thumb nails 306 is displayed. The thumb nails 306 correspond to images which are displayed on the album display window 900 of FIG. 7 and designated to be printed by the check boxes 901 checked.

Also, the list boxes 302 to 305 of FIG. 3 list the information acquired by the plug-in 107 at step S405.

Moreover, at step S407, the plug-in 107 lists up the file information of the image data 103 to be printed on the basis of the HTML file acquired from the server device 101 to create the first cache list information 109 and store it in the memory 108.

At step S408, it is checked whether or not an instruction of the printing execution is entered by the user operating the pointing device 205 to depress the print button 308 on the print setting window 301 of FIG. 3.

If the instruction of the printing execution is entered at step S408, the plug-in 107 acquires the print setting information input in the list boxes 302 to 305 of the print setting window 301 at step S409.

In FIG. 4B, at step S410, one of the file information of the image data 103 listed up in the first cache list information 109 is extracted.

At step S411, the plug-in 107 determines whether or not the file information extracted at step S410 is listed up in the second cache list information 111.

Note that the file information of the image data 103 that was the object to be printed at the previous time is listed up in the second cache list information 111. That is, the image data 103 listed up as the file information in the second cache list information 111 is stored in the print cache data 110.

If it is determined that there is no information at step S411, the procedure goes to step S412 where the plug-in 107 asks the server device 101 to provide the image data, because there is no cache for the image data 103 of object in the print cache data area 110 within the client terminal 105.

At step S413, the plug-in 107 acquires the image data 103 of object from the server device 101.

At step S414, the plug-in 107 stores the image data 103 acquired at step S413 in the print cache data area 110 within the client terminal 105, and the procedure goes to step S415.

On the other hand, if there is the information matched with the extracted file information in the second cache list information 111 at step S411, the procedure goes to step S415 by skipping the steps S412 to S414.

At step S415, the plug-in 107 acquires the image data 103 corresponding to the file information extracted at step S410 from the print cache data area 110.

At step S416, the plug-in 107 transfers the image data 103 acquired from the print cache data area 110 at step S415, along with the print setting information acquired at step S408, to the printer driver 112.

Note that the printer driver 112 generates one print job for each image data 103, employing the image data 103 received from the plug-in 107 and the print setting information, and further transfers it to the printer 113 to make the printing.

If the data transfer is completed at step S416, the plug-in 107 determines whether or not the transfer of all the image data 103 to be printed to the printer driver 112 is ended at step S417.

If it is determined that the transfer to the printer driver 112 is ended at step S417, the plug-in 107 goes to step S418 to copy the content of the first cache list information 109 to the second cache list information 112. That is, the second cache list information is updated with the first cache list information, whereby a series of printing process is ended.

If there is the image data 103 that has not been transferred at step S417, the procedure returns to step S410.

In this manner, the print cache data is accumulated within the client terminal, whereby the same data is printed continuously, there is no need for accessing the data on the server device every time, so that the smaller load on the network, the reduced communication cost, and the shorter printing time are effected.

[Second Embodiment]

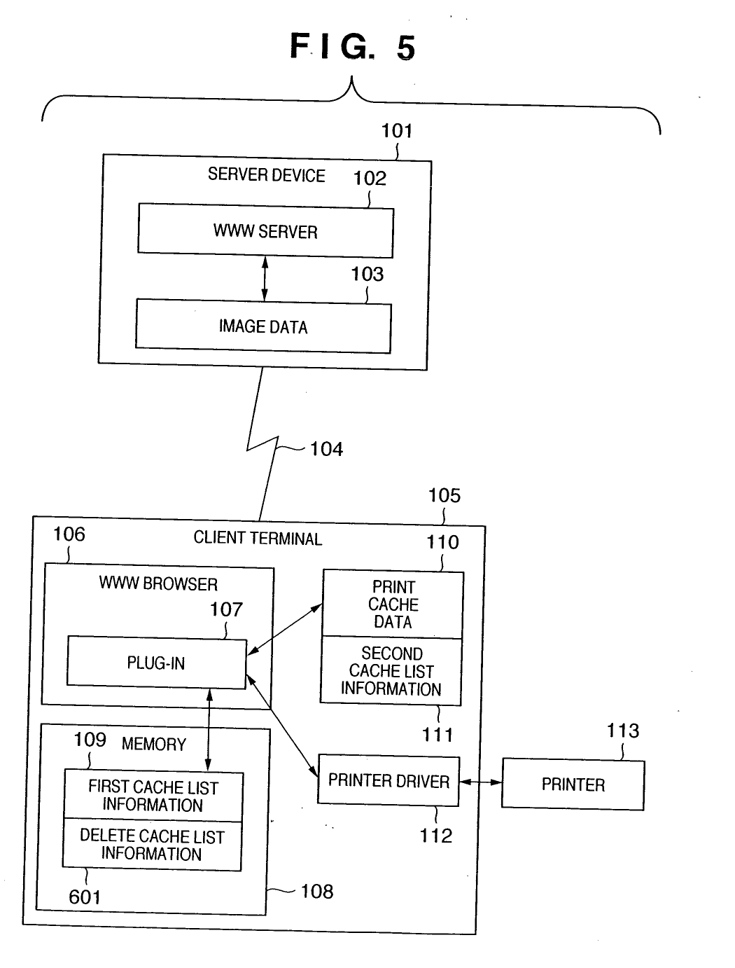

A second embodiment of the invention will be described below. FIG. 5 is a block diagram showing the configuration of an information processing system according to this embodiment.

In this embodiment, an area for a delete cache list information 601 is provided in addition to the memory 108 at the client terminal 105 according to the first embodiment. Other configuration is the same as in the first embodiment, whereby the same parts are designated by the same numerals, and not described here.

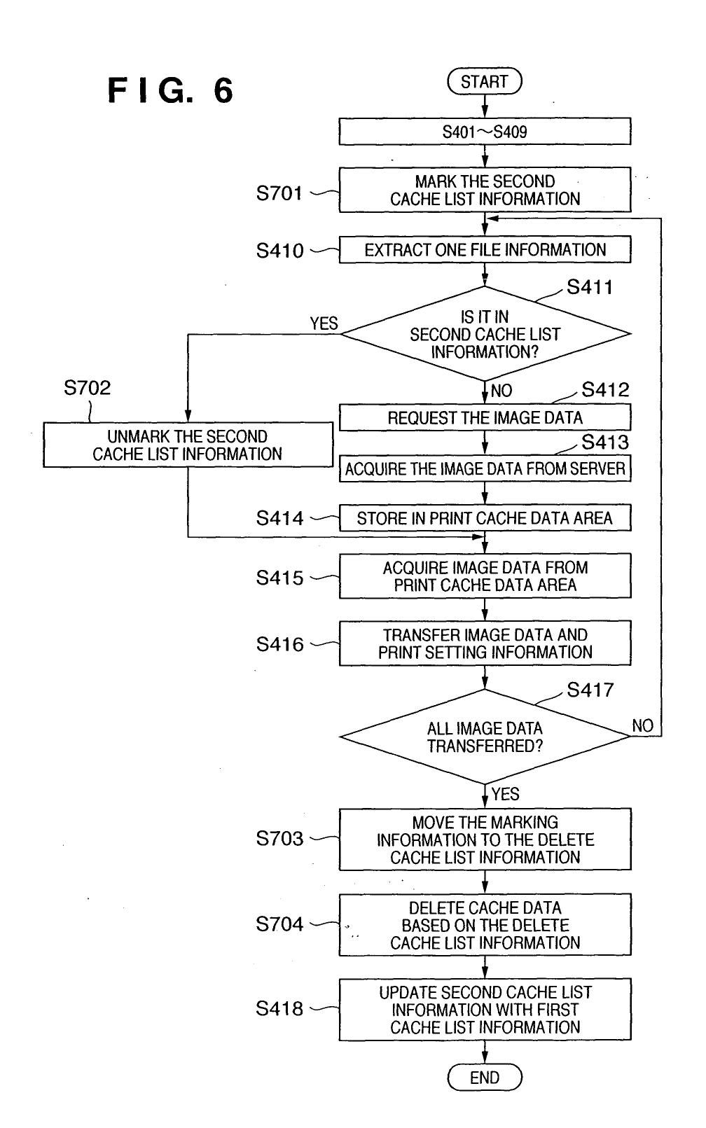

FIG. 6 is a flowchart showing the process of a plug-in program installed in the client terminal 105 of this embodiment. The plug-in 107 of this embodiment performs the steps S701 to S704 in addition to the process of the plug-in 107 of the first embodiment shown in FIGS. 4A and 4B.

That is, first of all, the plug-in 107 successively performs the steps S401 to S409 of FIG. 4A as previously described.

At step S701, the plug-in 107 puts a mark on the file information for all the image data 103 listed up in the second cache list information 111.

Then, the plug-in 107 extracts one of the file information for the image data 103 listed up in the first cache list information 109 in the same manner as at step S410 of FIG. 4B.

And the plug-in 107 retrieves the file information extracted at step S410 from the second cache list information 111 through the same processing at step S411 of FIG. 4B.

If the information matched with the extracted file information is present in the second cache list information 111 at step S411, the procedure goes to step S702, where the plug-in 107 takes the mark off the file information in the second cache list information, and then goes to step S417.

That is, the file information for the image data to be printed at this time among the image data 103 printed at the previous time is unmarked, but the file information for the image data 103 that has been printed at the previous time and that is not printed at this time is only left marked.

If the information matched with the extracted file information is not present in the second cache list information 111 at step S411, the plug-in 107 successively performs the same processing as at steps S412 to S414 in FIG. 4B, and the procedure goes to step S417.

If it is determined that the transfer of all the image data 103 to be printed to the printer driver 112 is ended at step S417, the procedure goes to step S703, where the plug-in 107 registers the file information marked within the second cache list information 111 in the delete cache list information 601. That is, the file information for the image data 103 that has been printed at the previous time and that is not printed at this time is registered in the delete cache list information 601.

At step S704, the plug-in 107 deletes the image data 103 corresponding to the file information registered in the delete cache list information 601 from the print cache data 110.

And the plug-in 107 performs the same processing as at step S418 of FIG. 4B.

In this manner, deleting the image data that is not repeatedly printed from the print cache data provides for efficient handling of the print cache data without suppressing memory resources within the client terminal.

[Other Embodiment]

Though the embodiments of the invention have been described above, this invention may be applied to the system consisting of one or more devices.

This invention may be achieved in such a manner that a software program for implementing the functions of the above embodiments is supplied directly or remotely to the system or device, and the computer for the system or device reads out and executes the program code. In this case, any other means than the program may be employed, so far as the functions of the program are provided.

Accordingly, to allow the computer to implement the functions of the invention, the program code itself installed in the computer may implement the invention. That is, the program code itself for implementing the functions of the invention may be covered in the claims of the invention.

In this case, the program may take any form such as an object code, a program executed by the interpreter, and a script data supplied to the OS so far as the functions of the program are provided.

Examples of the storage medium for supplying the program may include a floppy disk (registered trademark), a hard disk, an optical disk, a magneto-optical disk, MO, CD-ROM, CD-R, CD-RW, a magnetic tape, a non-volatile memory card, ROM, and DVD (DVD-ROM, DVD-R), for example.

Besides, a method for supplying the program includes connecting to a home page of the Internet, employing the browser of the client computer, and downloading a computer program itself of the invention or a compressed file with an automatic install function from the home page into a storage medium such as a hard disk. Also, the program code composing the program of the invention may be supplied by dividing it into a plurality of files, each file being downloaded from different home page. That is, the WWW server for downloading the program file for implementing the functions of the invention on the computer to a plurality of users may be covered in the claims of the invention.

Also, the program of the invention may be encrypted and stored in a storage medium such as a CD-ROM, and distributed to the user, whereby the encrypted program is executed using the key information for decryption that is downloaded via the Internet from a home page to the user clearing the given conditions, and installed in the computer.

Also, the functions of the above embodiments may be implemented by executing the read program on the computer, or performing a part or all of the actual process under the OS operating on the computer on the basis of the instructions of the program.

Moreover, the functions of the above embodiments may be implemented in such a manner that the program read from the storage medium is written into a function extension board inserted into the computer or a memory provided for a function extension unit connected with the computer, and a part or all of the actual process is performed by the CPU provided for the function extension board or the function extension unit on the basis of the instructions of the program.

With this invention, the image data acquired from the server device can be efficiently output to the printer.

The present invention is not limited to the above embodiments and various changes and modifications can be made within the spirit and scope of the present invention. Therefore, to apprise the public of the scope of the present invention, the following claims are made.

What is claimed is:

1. An information processing apparatus that can communicate with a server device via a network and control a printer, comprising:
image data memory for storing image data transmitted to said printer;
first image list memory for storing a list of identification information for the image data stored in said image data memory;
print instruction acquiring means for acquiring a print instruction indicating that the image data stored in said server device should be printed;
second image list memory for storing a list of identification information for the image data to be printed that is included in said print instruction acquired from said print instruction acquiring means;
comparison means for comparing the list stored in said first image list memory and the list stored in said second image list memory; and
download means for downloading, from said server device, the image data that is included in the list stored in said second image list memory but not included in the list stored in said first image list memory, as a result of comparison by said comparison means.

2. A function extension program that can communicate with a software for controlling a printer, said program causing a computer to execute:
a process of accepting a print instruction for a plurality of image data;
a process of acquiring a list of identification information for the image data transmitted to said printer from first image list memory storing said list;
a process of managing to store a list of identification information for the image data to be printed that is included in said print instruction in second image list memory;
a process of comparing the list stored in said first image list memory and the list stored in said second image list memory; and
a process of requesting the server device connected via a network for the image data that is included in the list stored in said second image list memory but not included in the list stored in said first image list memory, as a result of comparison by said comparison means.

3. The function extension program according to claim 2, further causing a computer to execute a process of managing to store the acquired image data by requesting the server device connected via the network in image data memory, and a process of updating the list stored in said first image list memory with the list stored in said second image list memory.

4. The function extension program according to claim 3, further causing a computer to execute a process of acquiring the image data included in the list stored in said second image list memory from said image data memory, depending on a result of said comparison.

5. The function extension program according to claim 3, further causing a computer to execute a process of transferring said acquired image data included in the list stored in said second image list memory to said software.

6. The function extension program according to claim 2, further causing a computer to execute a process of managing to delete, from said image data memory, the image data corresponding to the identification information that is included in the list stored in said first image list memory but not included in the list stored in said second image list memory, depending on a result of said comparison.

7. The function extension program according to claim 2, further causing a computer to execute a process of communicating with the WWW browser, wherein said function extension program is executed based on the description of an HTML file acquired by the WWW browser.

8. A computer readable storage medium storing the function extension program according to claim 2.

9. An information processing apparatus comprising:
means for executing the function extension program according to claim 2; and
means for communicating with the server device or the printer as defined in claim 2.

10. An information processing method for extending the functions of a software for controlling a printer, comprising:
a step of accepting a print instruction for a plurality of image data;
a step of acquiring a list of identification information for the image data transmitted to said printer from first image list memory storing said list;
a step of managing to store a list of identification information for the image data to be printed that is included in said print instruction in second image list memory;
a step of comparing the list stored in said first image list memory and the list stored in said second image list memory; and
a step of requesting the server device connected via a network for the image data that is included in the list stored in said second image list memory but not included in the list stored in said first image list memory, as a result of comparison by said comparison means.
